(19) United States
(12) Patent Application Publication
(10) Pub. No.: US 2019/0101086 A1
(43) Pub. Date: Apr. 4, 2019

(54) FUEL TANK

(71) Applicant: INI Power Systems, Inc., Morrisvillle, NC (US)

(72) Inventors: Daniel L. Furgurson, Raleigh, NC (US); Timothy C. Simmons, Durham, NC (US)

(21) Appl. No.: 15/722,582

(22) Filed: Oct. 2, 2017

(51) Int. Cl. F02M 37/00; F02M 37/22; F02M 1/16; F02B 63/04

(52) U.S. Cl. CPC F02M 37/0076; F02M 37/22; F02B 63/048; F02M 37/0052; F02M 1/16; F02M 37/007

(57) ABSTRACT

An adaptor includes a body having a cap portion, a bottle portion and an optional collar between the cap portion and the bottle portion. A supply fitting and a return fitting are coupled to the cap portion of the body. The adaptor may be coupled to a liquid fuel bottle, such as a white gasoline container, to form a removable fuel tank that may be used with a portable generator having a carbureted internal combustion engine.

### BACKGROUND

White gasoline (also known as “white gas” or “Coleman fuel”) is a generic term for a liquid hydrocarbon fuel that is primarily composed of naphtha. White gasoline is used as a power source in portable stoves, lanterns and model engines. Although it is capable of powering any engine that runs on a liquid hydrocarbon fuel, white gasoline is not intended for use in gasoline-powered internal combustion engines due to its low octane rating (50-55 octane), high combustion temperature and lack of additives such as anti-knock agents. White gasoline may be used in gasoline engines on an emergency basis but its use can lead to severe engine damage.

White gasoline is typically packaged and sold in one gallon containers. Most users transfer white gasoline from the one gallon containers to smaller refillable fuel bottles. For example, MSR® sells aluminum fuel bottles in 11 oz, 20 oz and 30 oz sizes (www.msrgear.com/catalog/product/view/id/17326/s/msr-fuel-bottles/category/5/). The portable fuel bottles are more convenient to transport and are specially designed to act as a fuel storage tank for portable liquid fuel stoves.

White gasoline must be pressurized to power a portable liquid fuel stove. MSR® fuel bottles have internal threads machined into the neck of the bottle to receive a hand-operated fuel pump (thesummitregister.com/what-you-didnt-know-about-msrs-iconic-fuel-bottles/). In use, the fuel pump is coupled to the fuel bottle, the fuel is pressurized, a fuel line is coupled to the fuel pump and the fuel line is coupled to the portable liquid fuel stove. Pressurized white gasoline then flows through the fuel line to the stove where it is vaporized at a burner. White gasoline fuel bottles are not intended to deliver fuel to devices other than portable liquid fuel stoves, or to deliver unpressurized fuel. In addition, fuel bottles that have been emptied during use must be depressurized before they can be replaced with full fuel bottles.

Generators for producing electricity are well known and have been commercially available for many years. These devices typically include an internal combustion engine. They are adapted to provide alternating current (AC) electricity, through a standard two-prong or three-prong plug receiver, at 120 or 240 volts, and at 50 to 60 Hz; also common is an additional 12-volt DC power port for charging lead acid batteries. Devices which use either gasoline-only or heavy fuels only, such as JP-8, diesel fuel, jet fuel or kerosene, are available. Flexible fuel generators, such as the IntelliGen Flex Fuel Generator from INI Power Systems, Inc. (Morrisville, N.C.) and those described in U.S. Pat. No. 9,175,601, are also available.

Gasoline has a low-flashpoint (less than −20° C.) and high autoignition temperature (greater than 200° C.). In operation gasoline requires the proper air to fuel ratio and a spark to induce and maintain ignition. A throttle and/or fuel injector is used to meter the fuel/air mixture which is sucked into the cylinders of the engine during operation. The low flashpoint and volatility of gasoline allows starting of the spark ignition engine at temperatures below freezing, allowing for operation over a broad range of temperatures, typically between −20° C. to 55° C. In order to obtain acceptable efficiency, a compression ratio of 8:1 to 12:1 is desirable for a gasoline-only engine, which is low enough to allow for manual pull-starting of the engine and the construction of simple lightweight portable engine devices made of aluminum.

Portable generators have a simple design in order to keep them light, low cost and durable. Such devices include an engine having a carburetor (which is part of a throttle assembly) for mixing air and fuel, and do not include a fuel injector. A carburetor main jet controls the maximum amount of fuel present in the air-fuel mixture exiting the throttle assembly, and a choke is used to reduce the amount of air in the air-fuel mixture, for starting the engine.

Small carbureted engines, such as those found in portable generators, need to be primed before use. Priming involves introducing a small amount of fuel to the carburetor to purge air from the carburetor and the fuel line before starting the engine. Introducing too much fuel during priming may flood the engine and prevent the engine from starting. In addition, engines typically are not designed to recapture the fuel used for priming and purging, which results in fuel being wasted.

### SUMMARY

In a first aspect, the invention is an adaptor comprising a body, a supply fitting, a return fitting, an optional fuel filter and a tube fitting. The body has a cap portion, a bottle portion and an optional collar between the cap portion and the bottle portion. The supply fitting is coupled to the cap portion. The return fitting is coupled to the cap portion. The optional fuel filter is coupled to the bottle portion and fluidly connected to the supply fitting. The tube fitting is coupled to the bottle portion and fluidly connected to the return fitting.

In a second aspect, the invention is a fuel tank comprising a bottle and an adaptor. The adaptor is coupled to the bottle. The adaptor includes a body, a supply fitting, a return fitting, an optional fuel filter and a tube fitting. The body has a cap portion, a bottle portion and an optional collar between the cap portion and the bottle portion. The supply fitting is coupled to the cap portion. The return fitting is coupled to the cap portion. The optional fuel filter is coupled to the bottle portion and fluidly connected to the supply fitting. The tube fitting is coupled to the bottle portion and fluidly connected to the return fitting.

In a third aspect, the invention is a portable generator comprising a carburetor, a fuel primer bulb, a generator supply fitting and a generator return fitting. The generator includes an internal combustion engine. The carburetor has an internal fuel pump. The fuel primer bulb is fluidly connected to the carburetor. The generator supply fitting is adapted to receive a supply fitting. The generator return fitting is adapted to receive a return fitting.

In a fourth aspect, the invention is a method of operating a portable generator having an internal combustion engine including a carburetor, comprising priming the carburetor with fuel from a removable fuel tank coupled to an adaptor; starting the internal combustion engine; and returning fuel that has not been combusted during the priming to the removable fuel tank coupled to the adaptor. Fuel that is used for the priming flows from a supply fitting coupled to the adaptor. Fuel that has not been combusted during the priming flows into a return fitting coupled to the adaptor.

In a fifth aspect, the invention is a portable generator comprising a carburetor and a fuel primer bulb. The generator includes an internal combustion engine. The carburetor has an internal fuel pump. The fuel primer bulb is fluidly connected to the carburetor. The portable generator is adapted to receive a removable fuel tank comprising a bottle and an adaptor, coupled to the bottle.

### Definitions

The term “quick-connect fitting” means a coupling having a male portion and a female portion, adapted to receive the male portion, for fluid transfer that is capable of being connected and disconnected without the use of tools. Quick-connect fittings are also known as push fittings, quick disconnects and quick release couplings. Quick-connect fittings may optionally include self-sealing valves to prevent fluid leakage when disconnected.

A “portable generator” is a generator that has an internal combustion engine and includes a pull start and a carburetor (as part of a throttle assembly), and uses a spark to ignite fuel-air mixture in the engine, and preferably does not include a battery for starting the engine, and does not include a fuel injector. Such a generator also includes a generator controller, for controlling various electrical and mechanical components of the generator. The compression ratio used in the engine is greater than 8.0:1, and more preferably 8.1:1 to 12.0:1. Preferably, the engine is air-cooled, has an aluminum cylinder or cylinders, and uses fixed spark plug ignition timing. Preferably, the engine is a 4 cycle, 50 cc engine. Examples of a portable generator include the YAMAHA® Inverter EF1000iS, EF2000iS, and EF2000iSH, as well as the HONDA® EU1000i, EU2000i and EB2000i.

The term “engine” means an internal combustion engine, which includes at least a cylinder, a piston which moves inside the cylinder, a spark plug, a fuel-air inlet to the cylinder, an exhaust outlet from the cylinder, and a drive shaft which moves with the piston, as well as an optional carburetor (as part of a throttle assembly), a fixed jet, and preferably does not include a fuel injector.

### BRIEF DESCRIPTION OF THE DRAWINGS

The invention can be better understood with reference to the following drawings and description.

FIG. 1 illustrates an adaptor.

FIG. 2 illustrates a sectioned view of an adaptor.

FIG. 3 illustrates an adaptor including an optional collar with an alternative collar design coupled to a bottle.

FIG. 4 illustrates a fuel tank.

FIG. 5 illustrates a sectioned view of a fuel tank.

FIG. 6 illustrates a fuel tank with an optional removable cap.

FIG. 7 illustrates a removable fuel tank in use with a portable generator.

FIG. 8 illustrates a partial view of a removable fuel tank in use with a portable generator.

FIG. 9 is a diagram illustrating how a removable fuel tank works with a generator.

FIG. 10 illustrates an exploded view of the front of a portable generator with a removable fuel tank.

FIG. 11 illustrates an exploded view of the back of a portable generator with a removable fuel tank.

### DETAILED DESCRIPTION

It would be desirable to adapt a commercially available liquid fuel container, such as an MSR® liquid fuel bottle, for use as a fuel tank with a portable generator powered by a carbureted engine. However, commercially available liquid fuel containers are not designed for use with carbureted internal combustion engines. For example, MSR® liquid fuel bottles are specifically designed to deliver pressurized white gasoline to a portable liquid fuel stove.

The present invention includes an adaptor that may be coupled to a liquid fuel bottle to form a removable fuel tank for a portable generator including a carbureted engine. The fuel tank delivers unpressurized fuel to the generator using a gravity-fed design. The adaptor includes two fittings that permit fuel to flow from the bottle to a carburetor, and fuel that has not been combusted to flow from the carburetor to the bottle. This bidirectional fuel flow increases the efficiency of a generator with a carbureted engine by recapturing the fuel that is used to prime and purge the carburetor so that it may be reused for combustion instead of being wasted. The removable fuel tank may be used with a novel generator, or may be used with a commercially available generator that has been modified for use with a removable fuel tank.

The fuel tank includes a number of design features that make it easy to insert and remove from a generator. The adaptor is designed to only allow the fuel tank to be inserted in the generator in the correct orientation. The fuel in the bottle is not pressurized, which allows empty fuel tanks to be immediately removed without depressurizing, and new fuel tanks to be used immediately after insertion without being pressurized. The adaptor may also include fittings that allow a user to insert and remove a fuel tank from a generator without the use of tools. These various features together allow for rapid one-handed insertion and removal of fuel tanks.

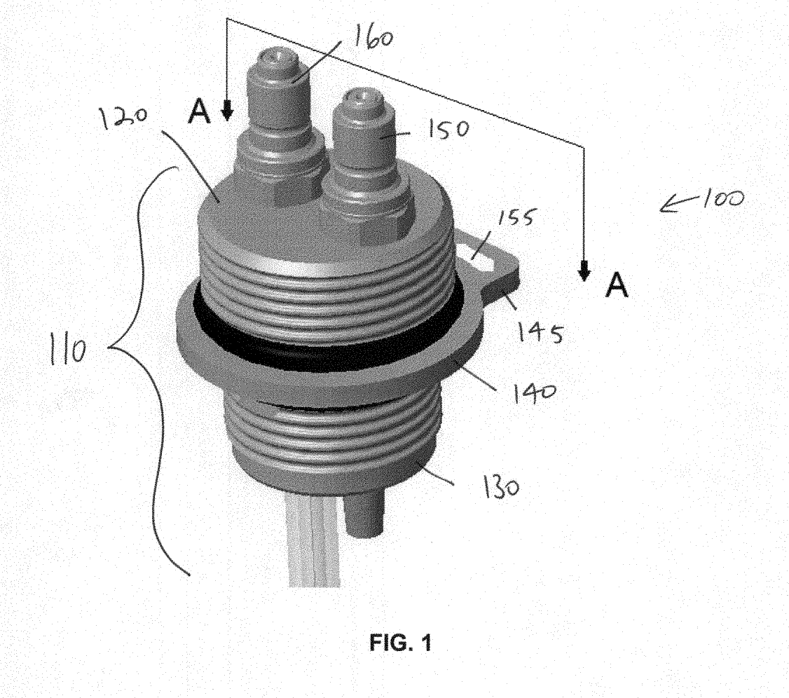

FIG. 1 illustrates an adaptor 100 for a liquid fuel bottle. The adaptor includes a body 110 having a cap portion 120, a bottle portion 130 and an optional collar 140 between the cap portion and the bottle portion. The collar includes an optional tab 145. The tab includes an optional opening 155. A supply fitting 150 and a return fitting 160 are coupled to the cap portion of the body.

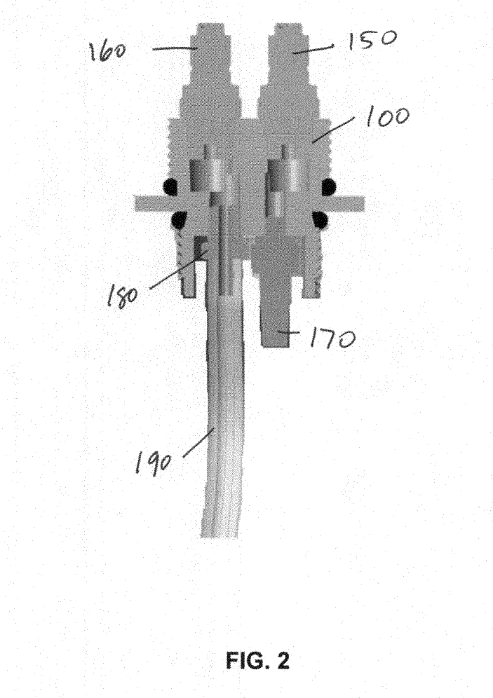

FIG. 2 illustrates a cross-sectioned view of the adaptor 100 shown in FIG. 1 taken along line AA. An optional fuel filter 170 is coupled to the bottle portion of the body and is fluidly connected to the supply fitting 150. A tube fitting 180 is coupled to the bottle portion of the body and is fluidly connected to the return fitting 160. A tube 190 is fluidly connected to the tube fitting.

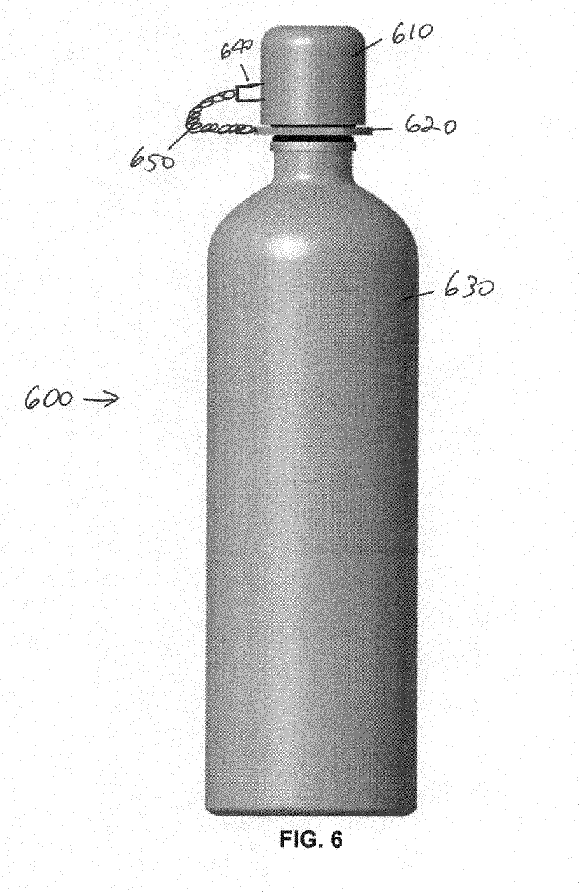

The body may be constructed of any durable, rigid material such as metals, plastics, or ceramics. The body may be monolithic, or may be composed of multiple components. As shown in FIG. 1, the cap portion and the bottle portion of the body are preferably threaded. Threading on the bottle portion allows the adaptor to be coupled to a bottle with an internally threaded neck, such as an MSR® liquid fuel bottle. Threading on the cap portion allows the adaptor to be coupled to a removable cap (see FIG. 6).

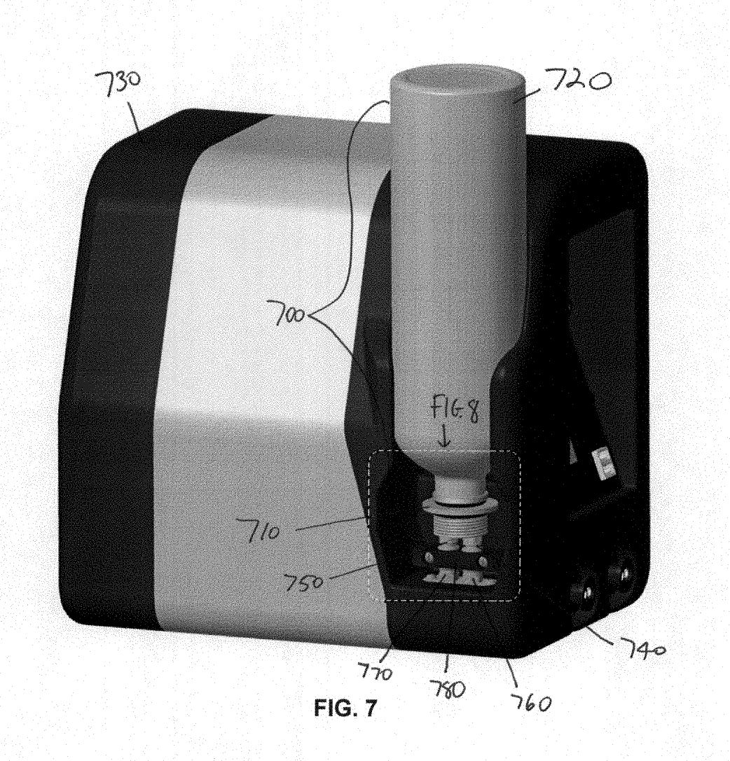

The supply fitting and the return fitting allow fuel to flow from the fuel tank to a carburetor, and fuel that has not been combusted to flow from the carburetor to the fuel tank, respectively. Preferably, the supply fitting and the return fitting are both male fittings that are adapted to be coupled to corresponding female fittings on a generator (see FIG. 7). The fittings may be any type of fitting suitable for fluid transfer, such as a metal compression fitting, push-to-pull compression fitting or quick-connect fitting. Preferably, the fittings are quick-connect fittings, which allow the fuel tank to be inserted and removed by hand and without the use of tools. The fittings preferably include self-sealing valves to prevent fuel from leaking out of the fuel tank when not in use.

The optional fuel filter prevents foreign material in the fuel tank from entering a generator fuel system as it flows through the supply fitting. The fuel filter preferably is removable so that it may be cleaned or replaced as it accumulates foreign material. Any small engine fuel filter that is properly sized to fit the adaptor may be used, such as commercially-available fuel filters designed for use with lawn mowers or snow blowers.

The tube fitting provides a connection point for a tube. The tube fitting may be any type of fitting that fits the adaptor and holds the tube in place. An example of a suitable tube fitting is a barb or hose barb.

The tube allows fuel returning from the carburetor to be returned to the fuel tank. The tube may be formed from any flexible material that is suitable for use with liquid fuels such as gasoline and white gasoline. Examples of suitable tube materials include polymers such as polyethylene, polypropylene, polyisoprene, polybutadiene, ethylene-propylene-diene copolymers (EPDM), styrene-butadiene copolymers (SBR), butadiene-acrylonitrile copolymers (NBR, or Buna-N), neoprene elastomer (polychloroprene and its copolymers), polyurethane elastomer and silicone elastomer.

The optional tab on the collar may assist in proper orienting of a fuel tank when coupling the fuel tank to a generator. The tab protrudes a sufficient distance from the collar to prevent the tab from being placed towards the generator body. This ensures that the fuel tank can only be inserted in an orientation that couples the supply fitting and the return fitting to the proper corresponding fittings on the generator body. The tab may optionally include an opening that passes through the tab. A fastener such as a chain or string may be inserted through the opening and coupled to a removable cap to secure the cap (see FIG. 6).

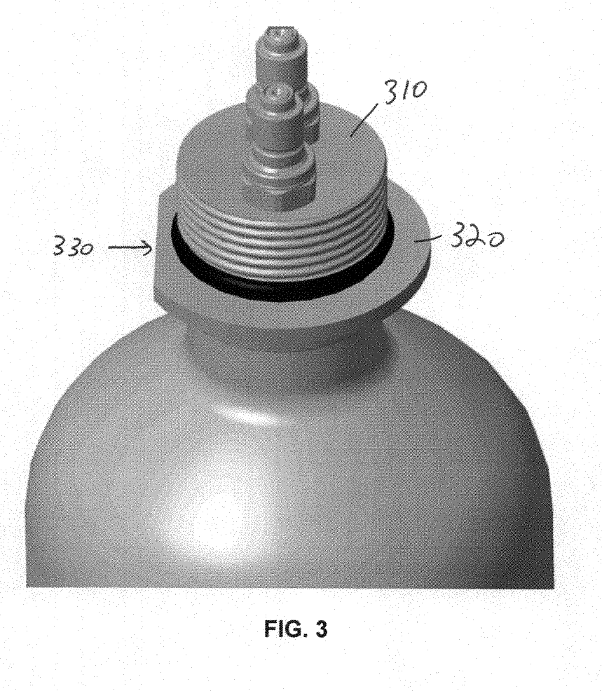

FIG. 3 illustrates an adaptor 310 including an optional collar with an alternative collar design coupled to a bottle. The collar 320 includes an optional flat section 330. The rounded portion of the collar extends a sufficient distance to only permit a fuel tank to be inserted with the flat section of the adaptor facing the generator body. This ensures that the fuel tank can only be inserted in an orientation that couples the supply fitting and the return fitting to the proper corresponding fittings on the generator body.

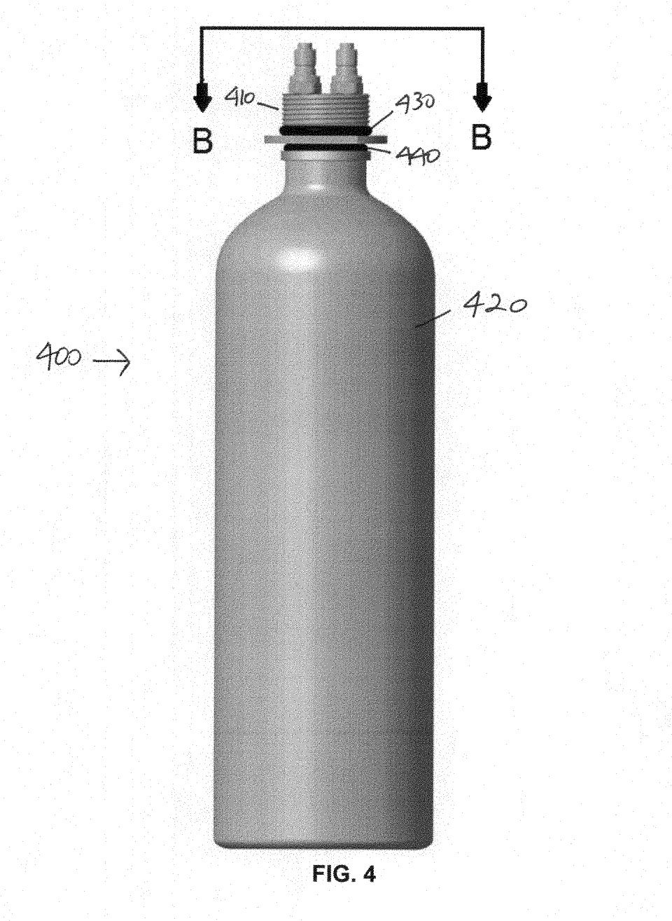

FIG. 4 illustrates a fuel tank 400. The fuel tank includes an adaptor 410 coupled to a bottle 420. An optional first gasket 430 is on the cap portion of the adaptor. An optional second gasket 440 is on the bottle portion of the adaptor. Preferably, the gaskets are O-rings.

The bottle may be constructed of any durable, rigid material that is suitable for storing liquid fuels, such as metals, plastics or ceramics. A preferred bottle material is aluminum. The bottle may have internal threading in the neck that allows the adaptor to be threaded onto the bottle. The bottle is preferably a commercially available white gasoline container, such as an MSR® liquid fuel bottle, a PRIMUS® fuel bottle or an OPTIMUS® fuel bottle. Preferred bottles include the 11 ounce, 20 ounce and 30 ounce liquid fuel bottles available from MSR® (Seattle, Wash., USA).

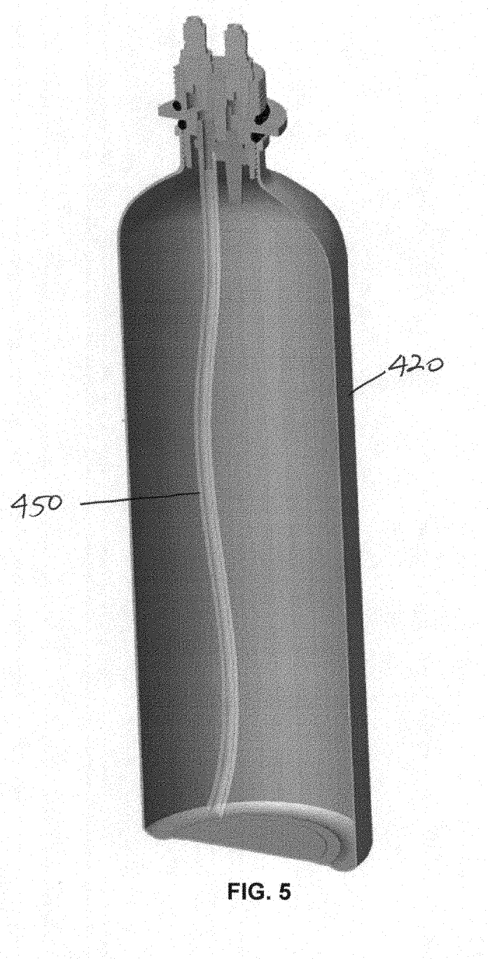

FIG. 5 illustrates a sectioned view of the fuel tank shown in FIG. 4 along line BB. A tube 450 extends substantially the length of the bottle 420. Although the length of the tube may vary, a tube that extends substantially the length of the bottle helps prevent the effect of fuel pressure from impeding the return flow of fuel back into the fuel tank from the carburetor.

FIG. 6 illustrates a fuel tank 600 with an optional removable cap 610. The fuel tank includes an adaptor 620 coupled to a bottle 630. The cap protects the adaptor when not in use. The cap is preferably threaded with threads that match the threading of the cap portion of the adaptor. Alternatively, the cap may be coupled to the adaptor without threading, such as by a press fit or snap fit. The cap may optionally include a fastening point 640 to allow the cap to be tethered to the adaptor with a fastener 650 such as a chain or string.

The fuel tank may contain any liquid fuel that is capable of powering a portable generator. Examples of liquid fuels include gasoline, white gasoline, diesel fuel, diesel 1, diesel 2, kerosene, JP-8, JP-5, F-76, DF2 aviation fuel, bio-diesel, diethyl ether and alcohol. A fuel tank may optionally be provided pre-filled with a liquid fuel.

A portable generator with a removable fuel tank includes a carbureted internal combustion engine. The carburetor preferably includes an internal fuel pump, which allows the removable fuel tank to deliver unpressurized fuel to the generator. The generator may include a fuel primer bulb, fluidly connected to the carburetor. The generator includes a generator supply fitting, adapted to receive a supply fitting, and a generator return fitting, adapted to receive a return fitting. The generator supply fitting and the generator return fitting may be any type of fitting suitable for fluid transfer that couples to the corresponding adaptor fittings. Preferably, the generator supply fitting and the generator return fitting are both female quick-connect fittings that are adapted to be coupled to corresponding male fittings on an adaptor (see FIG. 1).

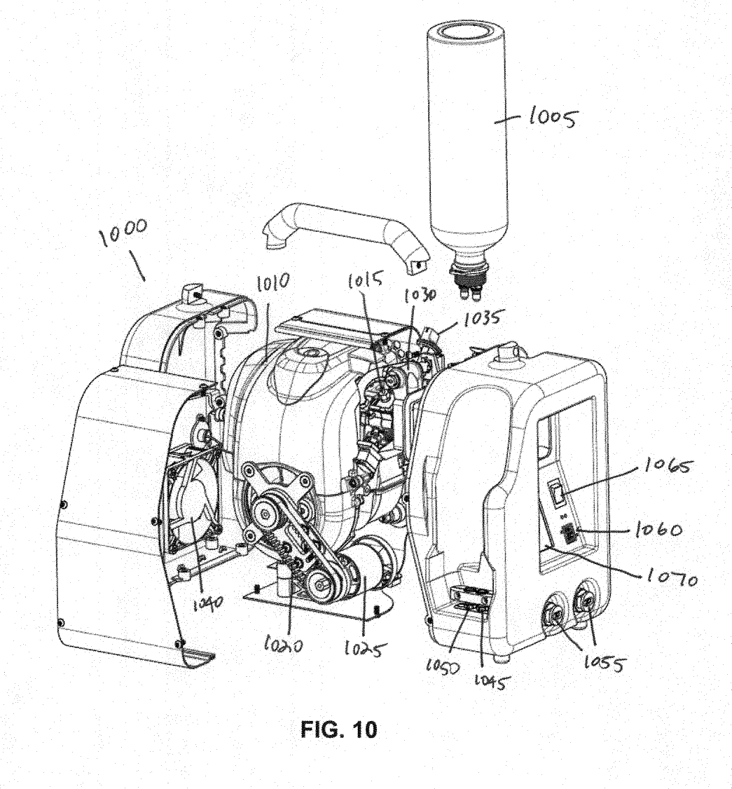

FIG. 10 illustrates an exploded view of the front of a portable generator 1000 with a removable fuel tank 1005. The generator includes an internal combustion engine 1010. The internal combustion engine may be a commercially available engine, such as the HONDA® GX25, GX35, GXH50, GXV50, GX100, GX120 or GX160 engine. The internal combustion engine includes a carburetor 1015, a transmission 1020, an alternator 1025, an air box 1030 and a choke 1035. The transmission may be a belt-drive transmission. The air box may include an integrated leaning valve. A cooling fan 1040 provides air cooling for the engine. A generator supply fitting 1045 and a generator return fitting 1050 are adapted for receiving corresponding fittings on the removable fuel tank. The power produced by the generator may be transmitted through an SAE 28V output 1055, a universal serial bus (USB) output 1060 or combinations thereof. The generator shown in FIG. 10 includes two SAE 28V outputs and two USB outputs. A switch 1065 is used to start and stop the generator. A user may control the generator through a touchscreen 1070.

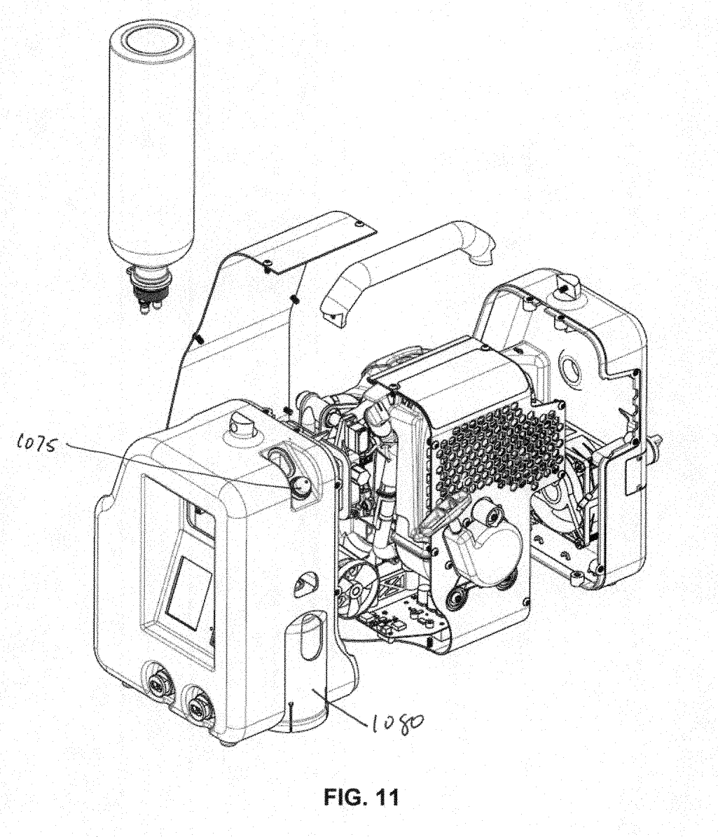

FIG. 11 illustrates an exploded view of the back of the portable generator with the removable fuel tank shown in FIG. 10. A fuel primer bulb 1075 allows the generator to be primed with fuel from the removable fuel tank prior to starting the engine. The generator may optionally include an integrated starting assist device 1080, such as a canister containing starting fluid. The starting assist device may include a substance to facilitate starting the engine, such as pressurized diethyl ether. A small amount of a low-boiling point low-flashpoint fuel, such as diethyl ether, delivered anywhere along the air intake path of a generator will allow the engine of the generator to be started with heavy fuels, including diesel fuel, diesel 1, diesel 2, kerosene, JP-8, JP-5, F-76, DF2 aviation fuel and bio-diesel (see U.S. Pat. No. 9,188,033 to Markoski et al.). Pressurized canisters of starting fluid are commercially available, such as VALVOLINE® Extra Strength Starting Fluid.

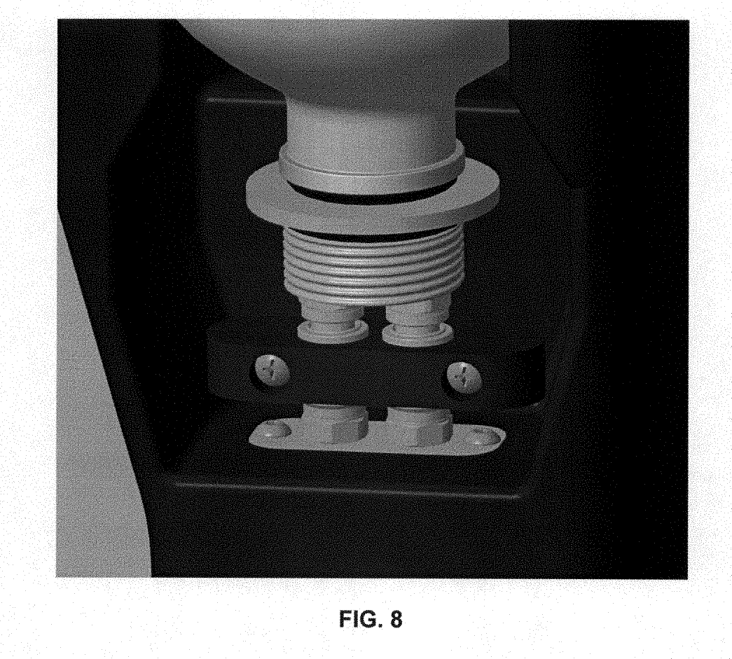

FIG. 7 illustrates a removable fuel tank 700 in use with a portable generator 730. The removable fuel tank includes an adaptor 710 coupled to a bottle 720. The fuel tank is inverted so that the liquid fuel may be gravity-fed to the generator. The adaptor includes a supply fitting 740 and a return fitting 750. The generator includes a generator supply fitting 760 adapted to receive the adaptor supply fitting and generator return fitting 770 adapted to receive the adaptor return fitting. A brace 780 circumscribes the generator supply fitting and generator return fitting and is coupled to the generator. The brace prevents the generator supply fitting and generator return fitting from being laterally displaced when the fuel tank is inserted or removed. FIG. 8 illustrates a partial view of the removable fuel tank in use with the portable generator shown in FIG. 7.

The generator may be a commercially available gasoline generator, such as the YAMAHA® Inverter EF1000iS, EF2000iS or EF2000iSH, or the HONDA® EU1000i, EU2000i or EB2000i, or a commercially available flexible fuel generator, such as the INI Power Systems 1 kW IntelliGen Flex Fuel Generator, 2 kW IntelliGen Flex Fuel Generator or 5 kW IntelliGen Flex Fuel Generator (Morrisville, N.C.), that has been modified to accept a removable fuel tank. The modification process includes removing the existing fuel tank, adding a generator supply fitting, adding a generator return fitting, optionally adding a brace that circumscribes the supply fitting and return fitting and is coupled to the generator housing, optionally adding a fuel primer bulb, optionally adding a one-way vent connected to the fuel line and optionally adding a custom housing to the generator.

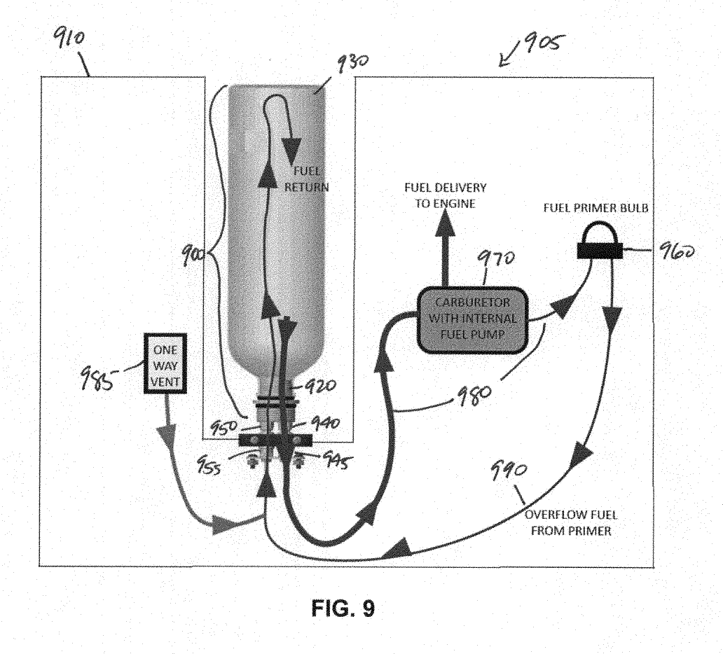

FIG. 9 is a diagram illustrating how a removable fuel tank 900 works with a generator 905. The generator includes a housing 910 that protects the internal components. The fuel tank includes an adaptor 920 coupled to a bottle 930. The adaptor includes a supply fitting 940 that is fluidly connected to a generator supply fitting 945, and a return fitting 950 that is fluidly connected to a generator return fitting 955. The generator includes a fuel primer bulb 960 that is fluidly connected to a carburetor 970 and the generator supply fitting through a supply fuel line 980. The fuel primer bulb is also fluidly connected to the generator return fitting through a return fuel line 990. A one-way vent 985 is fluidly connected to the return fuel line to allow ambient atmosphere to enter the fuel tank and prevent the formation of a vacuum within the fuel tank. The fuel tank is not pressurized, and the fuel tank and the fuel in the bottle are at ambient pressure.

In use, the fuel primer bulb draws fuel from the fuel tank to the carburetor to purge air from the carburetor and the supply fuel line before starting the engine. The engine may then be started. The return fuel line recaptures the fuel used to prime and purge the carburetor, as well as any overflow fuel that was drawn from the bottle, and returns the fuel to the fuel tank so that it may be used to power the generator. Fuel that is used for priming flows from a supply fitting coupled to the adaptor, while fuel that has not been combusted during priming flows into a return fitting coupled to the adaptor. After the engine has been started, unpressurized fuel flows from the inverted fuel tank under the power of gravity through the supply fitting and the supply fuel line into the carburetor. The carburetor then supplies the fuel to the engine using an internal fuel pump.

### REFERENCES

1. “White gas”, available online at en.wikipedia.org/wiki/White_gas (Mar. 7, 2017).
2. “Coleman fuel”, available online at en.wikipedia.org/wiki/Coleman_fuel (Nov. 17, 2016).
3. “MSR® Liquid Fuel Bottles”, available online at www.msrgear.com/catalog/product/view/id/17326/s/msr-fuel-bottles/category/5/ (accessed May 8, 2017).
4. “Fuel Bottle (1 L)—Primus”, available online at primus.us/products/fuel-bottle-1l (accessed May 8, 2017).
5. “Fuel Bottle L 1.0 L Child Safe Cap”, available online at www.optimusstoves.com/us/us/311-8018995-optimus-fuel-bottle-l-1.0-l-child-safe-cap (accessed May 8, 2017).
6. “What You Didn't Know About MSR'S Iconic Fuel Bottles”, available online at thesummitregister.com/what-you-didnt-know-about-msrs-iconic-fuel-bottles/ (Jul. 19, 2015).

What is claimed is:

1-14. (canceled)

15. A portable generator, having an internal combustion engine, comprising:
a carburetor, having an internal fuel pump,
a fuel primer bulb, fluidly connected to the carburetor,
a generator supply fitting, adapted to receive a supply fitting, and
a generator return fitting, adapted to receive a return fitting.

16. The portable generator of claim 15, further comprising a brace coupled to the generator,
wherein the brace circumscribes the generator supply fitting and the generator return fitting.

17. The portable generator of claim 15, wherein the generator supply fitting and the generator return fitting comprise quick-connect fittings.

18. (canceled)

19. The portable generator of claim 15, further comprising a supply fuel line, fluidly connected to the generator supply fitting, the carburetor and the fuel primer bulb, and
a return fuel line, fluidly connected to the generator return fitting, the carburetor and the fuel primer bulb.

20. The portable generator of claim 19, further comprising a vent, fluidly connected to the return fuel line.

21. The portable generator of claim 20, wherein the vent is a one-way vent.

22. The portable generator of claim 15, further comprising a removable fuel tank.

23. The portable generator of claim 22, wherein the removable fuel tank comprises a bottle and an adaptor, coupled to the bottle,
wherein the adaptor includes
a body, having
a cap portion,
a bottle portion, and
a collar, between the cap portion and the bottle portion,
a supply fitting, coupled to the cap portion,
a return fitting, coupled to the cap portion,
a fuel filter, coupled to the bottle portion and fluidly connected to the supply fitting, and
a tube fitting, coupled to the bottle portion and fluidly connected to the return fitting.

24. A method of operating the portable generator of claim 15, comprising:
priming the carburetor with fuel from a removable fuel tank coupled to an adaptor;
starting the internal combustion engine; and
returning fuel that has not been combusted during the priming to the removable fuel tank coupled to the adaptor;
wherein fuel that is used for the priming flows from a supply fitting coupled to the adaptor, and
fuel that has not been combusted during the priming flows into a return fitting coupled to the adaptor.

25. (canceled)

26. A portable generator, having an internal combustion engine, comprising:
a carburetor, having an internal fuel pump, and
a fuel primer bulb, fluidly connected to the carburetor,
wherein the generator is adapted to receive a removable fuel tank comprising a bottle and an adaptor, coupled to the bottle.

27. The portable generator of claim 26, wherein the adaptor includes a body, having a cap portion,
a bottle portion,
a collar, between the cap portion and the bottle portion,
a supply fitting, coupled to the cap portion, and
a return fitting, coupled to the cap portion.

28. The portable generator of claim 27, wherein the supply fitting and the return fitting are quick-connect fittings.

29. A portable generator without a built-in fuel tank, adapted to receive a removable fuel tank.

30. The portable generator of claim 29, wherein the generator comprises
an internal combustion engine,
a carburetor, having an internal fuel pump, and
a fuel primer bulb, fluidly connected to the carburetor.

31. The portable generator of claim 29, wherein the generator comprises a generator supply fitting, adapted to receive a supply fitting, and
a generator return fitting, adapted to receive a return fitting.
